(19) United States
(12) Patent Application Publication
(10) Pub. No.: US 2018/0014097 A1
(43) Pub. Date: Jan. 11, 2018

(54) INTEGRATED APPLICATION ASSEMBLY FOR A MULTIMEDIA SYSTEM

(71) Applicant: SZU-CHENG LIN, CHANGHUA City (TW)

(72) Inventor: SZU-CHENG LIN, CHANGHUA City (TW)

(21) Appl. No.: 15/458,681

(22) Filed: Mar. 14, 2017

(30) Foreign Application Priority Data
Jul. 6, 2016 (TW) 105210204

(51) Int. Cl. H04R 1/02; A47B 13/08; G06F 3/16; A47B 81/06; A47B 97/00

(52) U.S. Cl. CPC H04R 1/025; A47B 81/06; A47B 97/00; G06F 3/165; A47B 13/08; A47B 2200/0081; A47B 2220/0091; H04R 2420/09; A47B 2200/04

(57) ABSTRACT

An integrated application assembly for a multimedia system includes a multimedia system module comprised of a panel and a multimedia circuit module. The multimedia circuit module includes a Bluetooth module, a plurality of USB connection modules, an audio input device, an AUX indicating lamp, and a volume adjusting module. The Bluetooth module includes a Bluetooth module switch and a Bluetooth connection indicating lamp. The Bluetooth module switch and the Bluetooth connection indicating lamp are mounted on the panel. A plurality of audio output devices is connected to the multimedia system module. The multimedia system module and the audio output devices are mounted on a piece of furniture to achieve an integrated application.

### BACKGROUND OF THE INVENTION

The present invention relates to a technical field of a multimedia system and, more particularly, to an integrated application assembly for a multimedia system for integrating multimedia and transmission device, such as Bluetooth, USB, and audio input and output devices, onto a piece of furniture.

In the current information age, various multimedia devices flourish. As an example, besides recording and playing music, a smart phone can make phone calls, take pictures, and play games, almost everything. Furthermore, some of wire/wireless transmission protocols have been developed for use by the customers. Other smart phones include USB ports, Bluetooth wireless connection, WIFI wireless connection, and 3G and 4G network connection. Current multimedia displays can be directly connected to a network and provide options for USB ports or Bluetooth wireless connection, providing a wide variety of uses. However, current various current multimedia devices are used independently, such that each multimedia device needs a multimedia display and an audio output device. Namely, plural multimedia devices need plural multimedia displays and plural audio output devices, leading to considerable purchase costs and difficulties in disposition. Furthermore, disposition of plural multimedia devices could be messy. Improvement is, thus, necessary.

Because of the drawbacks of the above conventional structures, the customers long for development of a novel structure with more ideal utility, which is also the goal and direction of endeavor of the related industry.

Thus, in view of the above goal, a work with real utility is obtained by detailed design and careful assessment by Applicant based on many years of experience in production, development, and design of related products.

### BRIEF SUMMARY OF THE INVENTION

The primary objective of the present invention is to provide an integrated application assembly for a multimedia system for integrating multimedia and transmission device, such as Bluetooth, USB, and audio input and output devices, onto a piece of furniture.

To achieve the above objective, the present invention provides an integrated application assembly for a multimedia system including a multimedia system module comprised of a panel and a multimedia circuit module. The multimedia circuit module includes a Bluetooth module, a plurality of USB connection modules, an audio input device, an AUX indicating lamp, and a volume adjusting module. The Bluetooth module includes a Bluetooth module switch and a Bluetooth connection indicating lamp. The Bluetooth module switch and the Bluetooth connection indicating lamp are mounted on the panel. A plurality of audio output devices is connected to the multimedia system module. The multimedia system module and the audio output devices are mounted on a piece of furniture to achieve an integrated application.

In an example, the audio input device is a 3.5 mm socket. When an end of an audio line of a microphone or an audio source is inserted into the 3.5 mm socket, the AUX indicating lamp is turned on, and the other end of the audio line is connected to a multimedia player.

In an example, the multimedia player is an audio equipment, a mobile phone, a television, or an MP3 player.

In an example, when an end of a transmission/charging cable is inserted into one of the plurality of USB connection modules, and the other end of the transmission/charging cable is connected to a multimedia mobile carrier, a charging function is provided, and to-be-played music in the multimedia mobile carrier can be played.

In an example, the multimedia mobile carrier can be operated to play music via connection of the Bluetooth module.

In an example, the piece of furniture is a desk, an office desk, a closet, a television desk, or a wine closet.

In an example, each of the plurality of audio output devices is a speaker, a full-range speaker, a low-range independent speaker, a mid-range independent speaker, or a high-range independent speaker.

In an example, the layout of the piece of furniture and the plurality of audio output devices depends on the sound resonance effect to improve the voice output effect.

In an example, the Bluetooth signal of the Bluetooth module is connected to the multimedia mobile carrier or a plurality of multimedia displays.

The present invention will become clearer in light of the following detailed description of illustrative embodiments of this invention described in connection with the drawings.

### DESCRIPTION OF THE DRAWINGS

FIG. 1 is a perspective view of an integrated application assembly for a multimedia system of a first example according to the present invention.

FIG. 2 is a perspective view showing integration of the multimedia system according to the present invention on a piece of furniture.

FIG. 3 is a perspective view showing integration of the multimedia system according to the present invention on another piece of furniture.

FIG. 4 is a perspective view showing integration of the multimedia system on a piece of furniture of a second example according to the present invention.

### DETAILED DESCRIPTION OF THE INVENTION

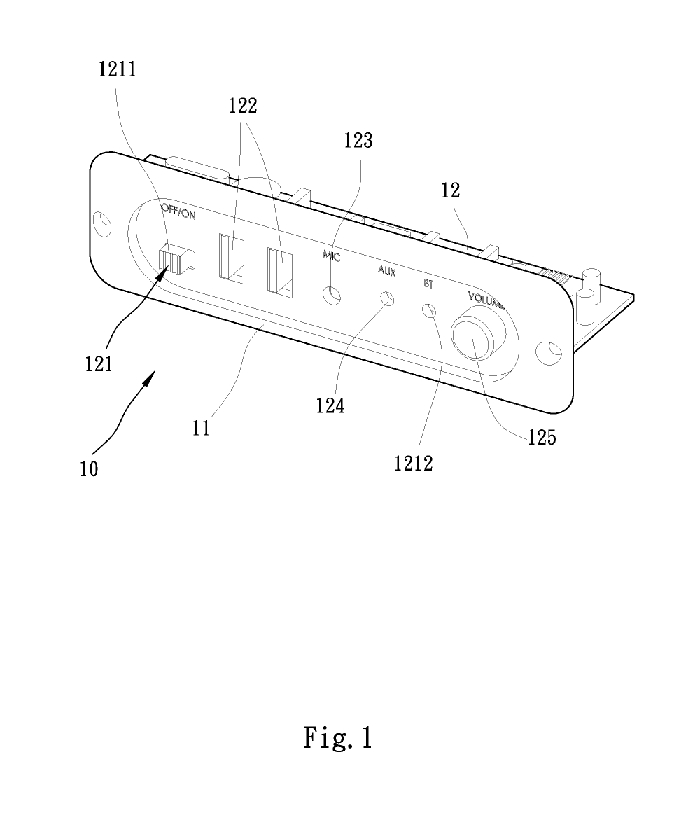

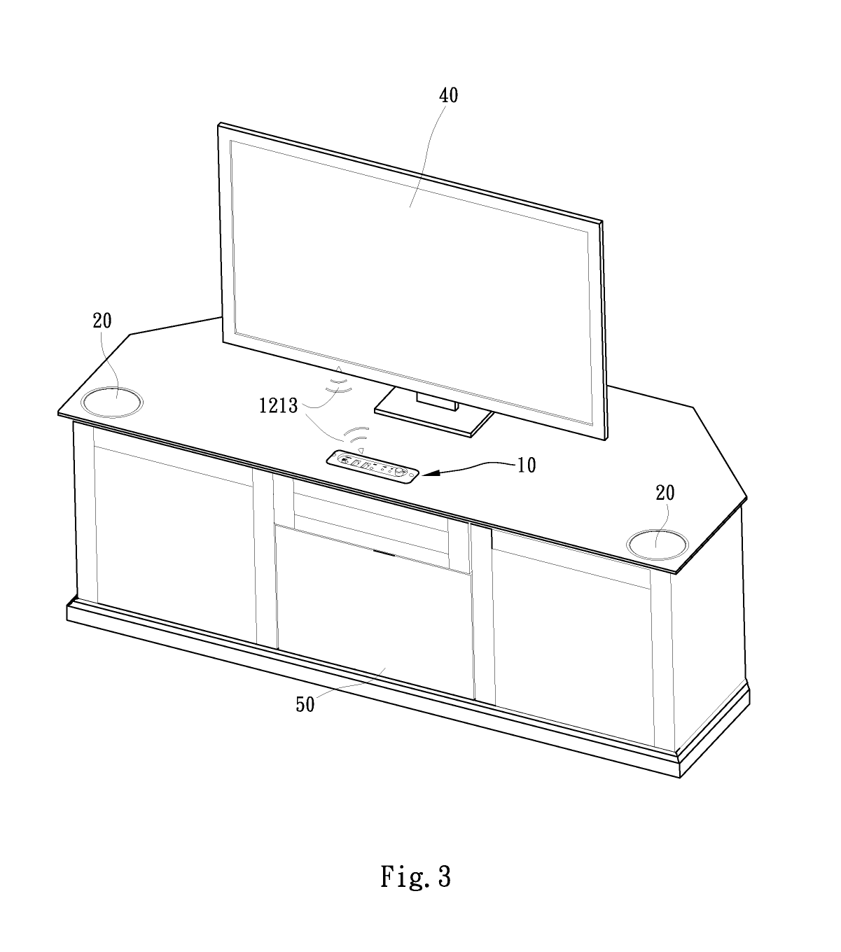

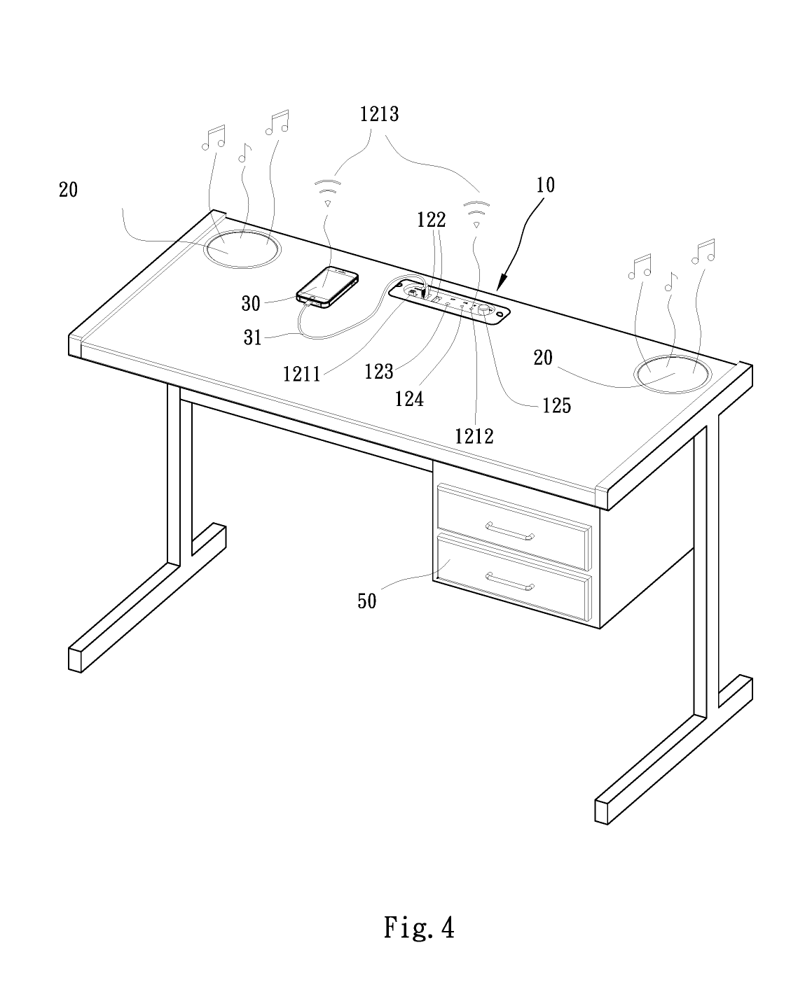

With reference to FIGS. 1-4, an integrated application assembly for a multimedia system according to the present invention includes a multimedia system module 10 comprised of a panel 11 and a multimedia circuit module 12. The multimedia circuit module 12 includes a Bluetooth module 121, a plurality of USB connection modules 122, an audio input device 123, an AUX indicating lamp 124, and a volume adjusting module 125. The Bluetooth module 121 includes a Bluetooth module switch 1211 and a Bluetooth connection indicating lamp 1212. The Bluetooth module switch 1211 and the Bluetooth connection indicating lamp 1212 are mounted on the panel 11.

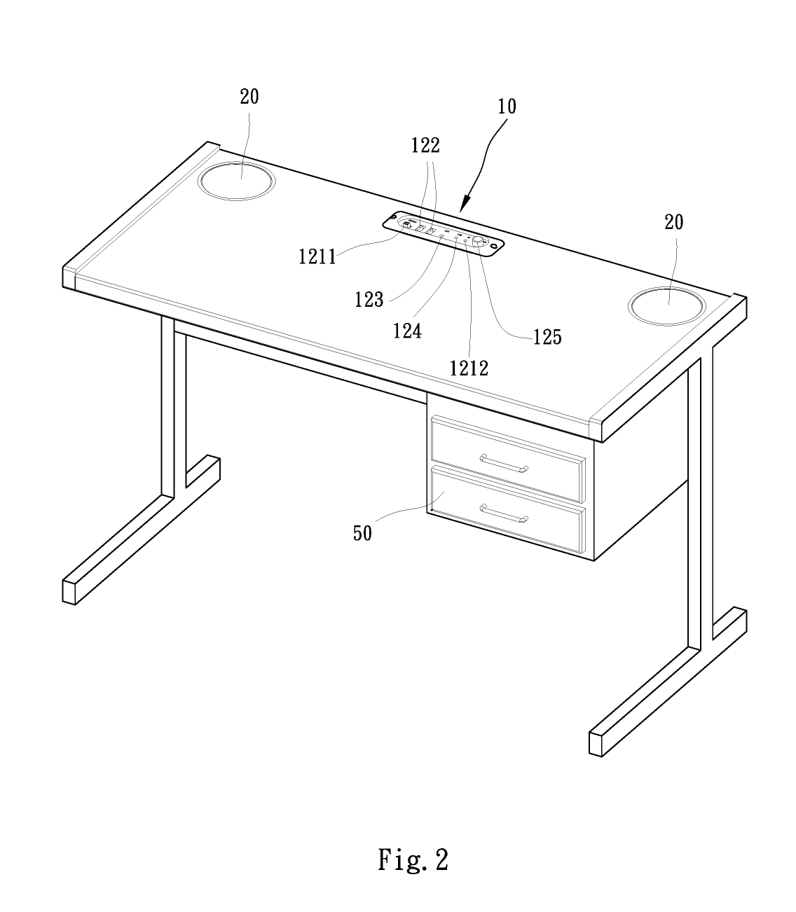

A plurality of audio output devices 20 is connected to the multimedia system modules 10. The multimedia system module 10 and the audio output devices 20 are mounted on a piece of furniture 50 to achieve an integrated application, as shown in FIG. 2.

The audio input device 123 can be a 3.5 mm socket. When an end of an audio line of a microphone or an audio source is inserted into the 3.5 mm socket, the AUX indicating lamp is turned on, and the other end of the audio line is connected to a multimedia player. The multimedia player can be an audio equipment, a mobile phone, a television, or an MP3 player.

When an end of a transmission/charging cable 31 is inserted into one of the plurality of USB connection modules 122 and the other end of the transmission/charging cable 31 is connected to a multimedia mobile carrier 30, a charging function is provided, and to-be-played music in the multimedia mobile carrier 30 can be played. The multimedia mobile carrier 30 can be operated to play music via connection signals 1213 of the Bluetooth module 121.

The piece of furniture can be a desk, an office desk, a closet, a television desk, or a wine closet.

Each audio output device 20 can be a speaker, a full-range speaker, a low-range independent speaker, a mid-range independent speaker, or a high-range independent speaker. The layout of the piece of furniture 50 and the audio output devices 20 depends on the sound resonance effect to improve the voice output effect.

A Bluetooth connection signal 1213 of the Bluetooth module 121 can be connected to the multimedia mobile carrier 30 or a plurality of multimedia displays 40.

In view of the foregoing, the integrated application assembly for a multimedia system according to the present invention is a novel comprehensive design with novelty and an inventive step. By integrating the multimedia system module 10, the audio output devices 20, and the wire/wireless connection device onto the piece of furniture 50, more convenient use of the multimedia mobile carrier 30 or the multimedia displays 40 is provided to better meet the industrial applicability.

Although specific embodiments have been illustrated and described, numerous modifications and variations are still possible without departing from the scope of the invention. The scope of the invention is limited by the accompanying claims.

1. An integrated application assembly for a multimedia system comprising:
a multimedia system module comprised of a panel and a multimedia circuit module, with the multimedia circuit module including a Bluetooth module, a plurality of USB connection modules, an audio input device, an AUX indicating lamp, and a volume adjusting module, with the Bluetooth module including a Bluetooth module switch and a Bluetooth connection indicating lamp, and with the Bluetooth module switch and the Bluetooth connection indicating lamp mounted on the panel;
a plurality of audio output devices connected to the multimedia system module; and
a piece of furniture, with the multimedia system module and the plurality of audio output devices mounted on the piece of furniture to achieve an integrated application.

2. The integrated application assembly for a multimedia system as claimed in claim 1, wherein the audio input device is a 3.5 mm socket, wherein when an end of an audio line of a microphone or an audio source is inserted into the 3.5 mm socket, the AUX indicating lamp is turned on, and another end of the audio line is connected to a multimedia player.

3. The integrated application assembly for a multimedia system as claimed in claim 2, wherein the multimedia player is an audio equipment, a mobile phone, a television, or an MP3 player.

4. The integrated application assembly for a multimedia system as claimed in claim 1, wherein when an end of a transmission/charging cable is inserted into one of the plurality of USB connection modules, and another end of the transmission/charging cable is connected to a multimedia mobile carrier, a charging function is provided, and to-be-played music in the multimedia mobile carrier is playable.

5. The integrated application assembly for a multimedia system as claimed in claim 4, wherein the multimedia mobile carrier is operable to play music via connection of the Bluetooth module.

6. The integrated application assembly for a multimedia system as claimed in claim 1, wherein the piece of furniture is a desk, an office desk, a closet, a television desk, or a wine closet.

7. The integrated application assembly for a multimedia system as claimed in claim 1, wherein each of the plurality of audio output devices is a speaker, a full-range speaker, a low-range independent speaker, a mid-range independent speaker, or a high-range independent speaker.

8. The integrated application assembly for a multimedia system as claimed in claim 1, wherein a layout of the piece of furniture and the plurality of audio output devices depends on a sound resonance effect to improve a voice output effect.

9. The integrated application assembly for a multimedia system as claimed in claim 4, wherein a Bluetooth signal of the Bluetooth module is connected to the multimedia mobile carrier or a plurality of multimedia displays.
